(19) United States
(12) Patent Application Publication
(10) Pub. No.: US 2009/0251050 A1
(43) Pub. Date: Oct. 8, 2009

(54) Organic light emitting display device

(76) Inventor: Sung-Hee Seo, Yongin-city (KR)

Correspondence Address: ROBERT E. BUSHNELL & LAW FIRM, 2029 K STREET NW, SUITE 600, WASHINGTON, DC, 20006-1004, US

(21) Appl. No.: 12/385,308

(22) Filed: Apr. 3, 2009

(30) Foreign Application Priority Data
Apr. 3, 2008 (KR) 10-2008-0031091

(51) Int. Cl. H01J 1/62

(52) U.S. Cl. 313/504

(57) ABSTRACT

An organic light emitting display device includes a substrate having a pixel unit for emitting light, a metal cap facing the substrate, a flexible printed circuit board coupled to the pixel unit of the substrate and arranged in a manner that the metal cap is arranged between the substrate and the flexible printed circuit board, and an adhesive member formed between the flexible circuit board and the metal cap. The adhesive member fills the entire space formed between the flexible circuit board and the metal cap. The construction of the adhesive member removes noise that can be generated during the operation of the organic light emitting display device.

### CLAIM OF PRIORITY

This application makes reference to, incorporates the same herein, and claims all benefits accruing under 35 U.S.C. §119 from an application for ORGANIC LIGHT EMITTING DISPLAY DEVICE earlier filed in the Korean Intellectual Property Office on the 3 Apr. 2008 and there duly assigned Serial No. 10-2008-0031091.

### BACKGROUND OF THE INVENTION

1. Field of the Invention

The present invention relates to an organic light emitting display device, and more particularly to an organic light emitting display device capable of removing acoustic noises that are generated during driving the organic light emitting display device.

2. Description of the Related Art

In recent years, there have been developed various flat panel displays capable of reducing a weight and volume which are unfavorable in a cathode ray tube. The flat panel display devices include a liquid crystal display (LCD), a field emission display (FED), a plasma display panel (PDP), an organic light emitting display (OLED), etc.

Here, the liquid crystal display and the organic light emitting display have taken attentions as alternatives to solve the problems of a conventional cathode ray tube, because the liquid crystal display and the organic light emitting display have advantages that they are manufactured with a small and light weight scale, and also are driven at low consumption power. Therefore, the liquid crystal display and the organic light emitting display have been used to be installed in portable devices such as mobile phones and personal digital assistants (PDAs), as well as medium-to-large products such as monitors and TVs.

In particular, the liquid crystal display and/or the organic light emitting display have recently been used in most of display units of the most portable devices such as mobile phones or PDAs.

However, for the conventional portable display device, the reduction in the entire thickness of the display devices and the removal of unnecessary protective elements are necessary according to a trend toward small-sized and slim portable devices. As a result, the portable display devices are being manufactured in a slim size.

In particular, an adhesive tape used in the portable display devices is formed in the minimum areas of the portable display devices to facilitate the slimness and the reduction in the manufacturing cost.

However, when an adhesion area of the adhesive tape is reduced, an adhesive force is reduced, and its components may get loosened due to the reduced adhesive force.

Also, when some of the components get loosened, an air layer formed between the components functions as a dielectric. Therefore, the conductive components and the dielectric air layer may cause acoustic noises since the air layer operates as a capacitor speaker.

In general, the conductive materials between conductive bodies are vibrated between the conductive bodies when electric current flows in the conductive bodies, and sounds are then amplified by the vibration. In this case, the conductive materials serve as the capacitor speaker.

At this time, harsh vibrating sounds, that is, noises are recognized by a user since the vibrating sounds have a frequency within a human audio bandwidth (20 Hz˜20 kHz).

### SUMMARY OF THE INVENTION

Accordingly, the present invention is designed to solve such drawbacks of the prior art, and therefore an object of the present invention is to provide an organic light emitting display device capable of preventing an adhesive member from getting loosened since an insulating adhesive member is formed on the entire surface with which the metal cap and the flexible printed circuit board (FPCB) are overlapped to attach the metal cap and the FPCB to each other, the entire surface being formed between the metal cap and the FPCB formed on the metal cap, and also removing acoustic noises that are caused due to the vibration of an air layer by removing the air layer formed in a space between the metal cap and the flexible printed circuit board.

One embodiment of the present invention is achieved by providing an organic light emitting display device including a substrate having a pixel unit for emitting light, a metal cap facing the substrate, a pad unit formed on an edge portion of the substrate to transmit a driving signal to the pixel unit of the substrate, a flexible printed circuit board coupled to the pad unit to supply the driving signal, and an adhesive member formed between the flexible circuit board and the metal cap. The metal cap is arranged between the substrate and the flexible printed circuit board. The adhesive member fills the entire space formed between the flexible circuit board and the metal cap.

The adhesive member may be formed of insulating materials, and a plurality of conductive lines may be formed on the flexible printed circuit board. The substrate may comprise scan lines extending in a direction and data lines extending in another direction. The pixel unit may comprise a plurality of pixels for emitting light. The pixels may be formed at intersections of the scan lines and the data lines.

The adhesive member may substantially fit into an entire overlapping space formed between the flexible circuit board and the metal cap. Edge portions of the metal cap may adhere to a surface of the substrate. The metal cap may encapsulate a space formed between the metal cap and the substrate.

As described above, the organic light emitting display device according to the present invention may be useful to prevent an adhesive member from getting loose since an insulating adhesive member is formed on the entire surface with which the metal cap and the flexible printed circuit board are overlapped to attach the metal cap and flexible printed circuit board to each other, the entire surface being formed between the metal cap and the flexible printed circuit board formed on the metal cap, and also to remove acoustic noises that are caused due to the vibration of an air layer by removing the air layer formed in a space between the metal cap and the flexible printed circuit board.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a plane view showing an organic light emitting display device according to one exemplary embodiment of the present invention.

FIG. 2 is a cross-sectional view showing some region (I-I′) of the organic light emitting display device as shown in FIG. 1.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the element or be indirectly on the element with one or more intervening elements interposed therebetween. Also, when an element is referred to as being “connected to” another element, it can be directly connected to the element or be indirectly connected to the element with one or more intervening elements interposed therebetween. Hereinafter, like reference numerals refer to like elements.

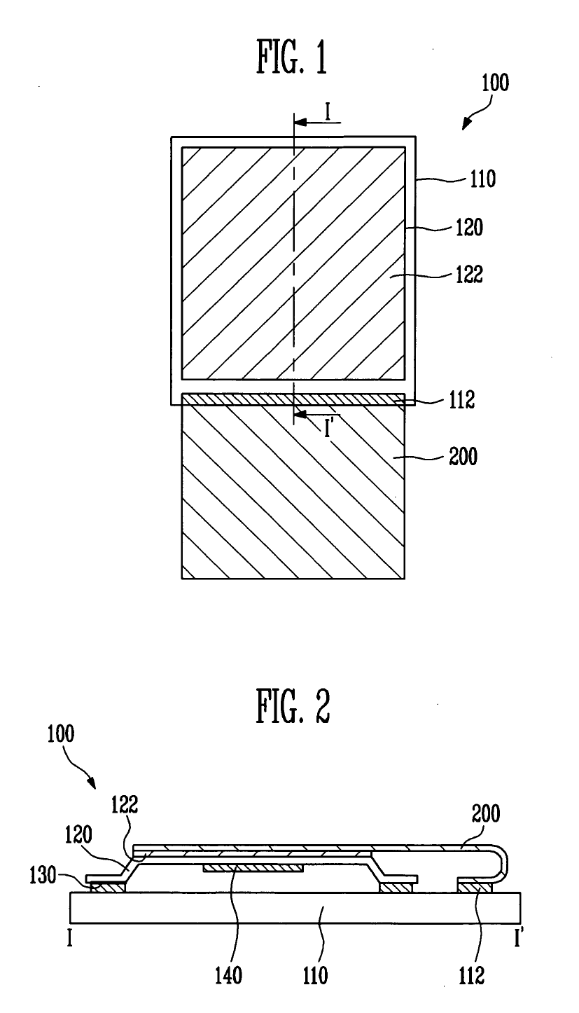

FIG. 1 is a plane view showing an organic light emitting display device according to one exemplary embodiment of the present invention, and FIG. 2 is a cross-sectional view showing some region (I-I′) of the organic light emitting display device as shown in FIG. 1.

Referring to FIGS. 1 and 2, the organic light emitting display device 100 according to one exemplary embodiment of the present invention includes a substrate 110 and a metal cap 120. Here, a pixel unit (not shown) including a plurality of pixels is formed in the substrate 110. The metal cap 120 is disposed to face the substrate 110 for encapsulation and attached to the substrate 110 by a sealant 130, such as epoxy, that is formed on an edge region of the substrate 110.

Scan lines extend in a direction and data lines extend in another direction in the pixel unit of the substrate 110. Pixels are formed at intersections of the scan lines and the data lines.

At this time, an organic light emitting element (not shown) is formed in each of the pixels. In this case, the organic light emitting element includes an anode electrode, a cathode electrode, and an organic thin film layer formed between the anode electrode and the cathode electrode and including a hole transport layer, an organic light emitting layer, and an electron transport layer.

However, the organic light emitting element is vulnerable to hydrogen and oxygen since the organic light emitting element includes an organic substance. Also, the cathode electrode formed in the outermost layer of the organic light emitting element may deteriorate by the contact with moisture in the air since the cathode electrode is formed of metallic materials. Therefore, the electrical characteristics and light emission characteristics of the organic light emitting element may easily deteriorate.

To prevent the deterioration, a portion of the substrate 110 is encapsulated with a container, for example a metal cap 120, that is produced in the form of a metallic can or cup. Edge portions of the metal cap 120 are attached to the substrate 110 through sealant 130, and therefore the space formed between the metal cap 120 and an upper surface of the substrate 110 is encapsulated. A moisture absorbing agent 140 can be formed inside the encapsulated space. The encapsulation process is carried out by forming a moisture absorbing agent 140 on the metal cap 120 and attaching the substrate 110 to the metal cap 120 under an inert gas atmosphere, such as nitrogen (N2) or argon (Ar), by using the sealant 130.

Also, a pad unit 112 is formed on one edge portion of the substrate 110 so as to transmit a driving signal to the organic light emitting element formed in the pixel unit of the substrate 110. The pad unit 112 is coupled to a flexible printed circuit board (FPCB) 200 that supplies a driving signal applied from an external device.

FIG. 1 shows that the flexible printed circuit board 200 is arranged in an unfolded form, but as shown in FIG. 2, it can bend over to be arranged on the top of the metal cap 120.

A plurality of conductive lines are formed on the flexible printed circuit board 200, and a driver IC (not shown) for driving a pixel unit may be installed in the flexible printed circuit board 200 if necessary.

In the contemporary technology, when the flexible printed circuit board 200 is attached to the metal cap 120, an adhesive tape, which attaches the flexible printed circuit board 200 to the metal cap 120, is formed only in an edge region of the metal cap 120 for cost efficiency.

However, when an adhesion area of the adhesive tape is reduced, an adhesive force to the flexible printed circuit board 200 is reduced, and some portions of the flexible printed circuit board 200 may get loosened due to the poor adhesive force.

Also, when the adhesive tape is formed only in an edge region of the metal cap 120 and the flexible printed circuit board 200 is then attached to the metal cap 120, a central region of the metal cap 120, which is free from an adhesive tape, has an empty space that is as thick as the adhesive tape. In this case, an air layer is formed in the space.

The air layer functions as a dielectric, as described above. As a result, the conductive metal cap 120, the conductive lines formed on the flexible printed circuit board 200 and the air layer as the dielectric may operate as a capacitor speaker to cause acoustic noises. At this time, harsh vibrating sounds, which are noises, are recognized by a user since the vibrating sounds have a frequency within a human audio bandwidth (20 Hz˜20 kHz).

The present invention is designed to solve such drawbacks of the prior art. The organic light emitting display device 100 of the present invention includes an adhesive member 122 formed of an insulating material. The insulating adhesive member 122 is formed between the metal cap 120 and the flexible printed circuit board 200. In one embodiment, the adhesive member 122 fills the entire space formed between the metal cap 120 and the flexible printed circuit board 200. When the flexible printed circuit board 200 is placed on the top of the metal cap 120, depending on the sizes of the flexible printed circuit board 200 and the metal cap 120, a portion of the metal cap 120 may overlap with the flexible printed circuit board 200, and another portion may not overlap with the flexible printed circuit board 200. Therefore, the overlapping portion forms an overlapping space between the flexible printed circuit board 200 and the metal cap 120. In another embodiment, the adhesive member substantially fits into the entire overlapping space formed between the flexible circuit board and the metal cap.

As described above, the insulating adhesive member 122 is formed between the metal cap 120 and the flexible printed circuit board 200 formed on the metal cap 120 according to the present invention. Therefore, it is possible to remove any air layer from the central region of the metal cap 120, wherein the air layer functions as the dielectric since the adhesive tape was formed only in the edge region of the metal cap 120 in the prior art.

That is to say, the adhesion of the metal cap 120 to the flexible printed circuit board 200 may be improved when the metal cap 120 is attached to the flexible printed circuit board 200 since the insulating adhesive member 122 is formed in the entire surface with which the flexible printed circuit board 200 overlaps with the top region of the metal cap 120. Also, it is possible to remove acoustic noises by preventing vibrations by the capacitor speaker, the acoustic noises being caused by the vibrations in the air layer between the metal cap 120 and the flexible printed circuit board 200.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display device, comprising:
a substrate having a pixel unit for emitting light;
a metal cap facing the substrate;
a pad unit formed on an edge portion of the substrate to transmit a driving signal to the pixel unit of the substrate;
a flexible printed circuit board coupled to the pad unit to supply the driving signal, the metal cap being arranged between the substrate and the flexible printed circuit board; and
an adhesive member formed between the flexible circuit board and the metal cap, the adhesive member filling the entire space formed between the flexible circuit board and the metal cap.

2. The organic light emitting display device according to claim 1, wherein the adhesive member is made of an insulating material.

3. The organic light emitting display device according to claim 1, wherein a plurality of conductive lines are formed on the flexible printed circuit board.

4. The organic light emitting display device according to claim 1, wherein the substrate comprises scan lines extending in a direction and data lines extending in another direction, and the pixel unit comprises a plurality of pixels for emitting light, the pixels being formed at intersections of the scan lines and the data lines.

5. The organic light emitting display device according to claim 4, wherein an organic light emitting element is formed in each of the pixels.

6. The organic light emitting display device according to claim 1, wherein the adhesive member substantially fits into an entire overlapping space formed between the flexible circuit board and the metal cap.

7. The organic light emitting display device according to claim 1, wherein edge portions of the metal cap adhere to a surface of the substrate, the metal cap encapsulating a space formed between the metal cap and the substrate.
